(19) United States
(12) Patent Application Publication
(10) Pub. No.: US 2026/0252326 A1
(43) Pub. Date: Aug. 27, 2026

(54) COMPUTATION DEVICE, COMPUTATION METHOD, AND RECORDING MEDIUM

(71) Applicant: NEC Corporation, Minato-ku, Tokyo (JP)

(72) Inventor: Kazuhisa ISHIZAKA, Tokyo (JP)

(73) Assignee: NEC Corporation, Minato-ku, Tokyo (JP)

(21) Appl. No.: 18/875,769

(22) PCT Filed: Jun. 23, 2022
(86) PCT No.: PCT/JP2022/025093

§ 371 Date: Dec. 17, 2024

(51) Int. Cl. G06F 8/41

(52) U.S. Cl. CPC G06F 8/41

(57) ABSTRACT

A computation device generates an intermediate representation corresponding to a part of a source program, which is a program to be executed. The computation device determines that, among operations indicated by the intermediate representation, an operation a number of times of an object for which is referenced in the source program is one or less is convertible to another operation. The object corresponds to a result of the operation. The computation device performs a process for converting the intermediate representation, based on a result of determining whether or not the operation is convertible to another operation. The computation device executes the intermediate representation after the process for converting the intermediate representation.

### TECHNICAL FIELD

The present invention relates to a computation device, a computation method, and a recording medium.

### BACKGROUND ART

After a source program is converted to intermediate code, the intermediate code may be optimized.

For example, in the method described in Patent Document 1, the analysis information of the source code and the correspondence between the analysis information and the code instructions are embedded in the intermediate code, and optimization is performed by fusing each module for each intermediate code for each module.

### PRIOR ART DOCUMENTS

### Patent Documents

Patent Document 1: Japanese Unexamined Patent Application Publication, First Publication No. 2014-219858

### SUMMARY OF THE INVENTION

### Problems to be Solved by the Invention

In the case of performing a computational conversion in an intermediate representation, such as intermediate code optimization, it is desirable to be able to detect the portion of the intermediate representation that can be converted to other operations with as little load as possible.

An example object of this invention is to provide a computation device, a computation method, and a recording medium that can solve the above-mentioned problems.

### Means for Solving the Problem

According to the first example aspect of the invention, a computation device includes: an intermediate representation generation means that generates an intermediate representation corresponding to a part of a source program, which is a program to be executed; a convertibility determination means that determines that, among operations indicated by the intermediate representation, an operation a number of times of an object for which is referenced in the source program is one or less is convertible to another operation, the object corresponding to a result of the operation; a conversion means that performs a process for converting the intermediate representation, based on a result of determining whether or not the operation is convertible to another operation; and an intermediate representation execution means that executes the intermediate representation after the process is performed by the conversion means.

According to the second example aspect of the invention, a computation method executed by a computer includes: generating an intermediate representation corresponding to a part of a source program, which is a program to be executed; determining that, among operations indicated by the intermediate representation, an operation a number of times of an object for which is referenced in the source program is one or less is convertible to another operation, the object corresponding to a result of the operation; performing a process for converting the intermediate representation, based on a result of determining whether or not the operation is convertible to another operation; and executing the intermediate representation after the process for converting the intermediate representation.

According to the third example aspect of the invention, a recording medium records a program for causing a computer to execute: generating an intermediate representation corresponding to a part of a source program, which is a program to be executed; determining that, among operations indicated by the intermediate representation, an operation a number of times of an object for which is referenced in the source program is one or less is convertible to another operation, the object corresponding to a result of the operation; performing a process for converting the intermediate representation, based on a result of determining whether or not the operation is convertible to another operation; and executing the intermediate representation after the process for converting the intermediate representation.

### Effect of Invention

According to this invention, the portion of the intermediate representation that can be converted to other operations can be detected with a relatively small load.

### BRIEF DESCRIPTION OF THE DRAWINGS

FIG. 1 is a diagram that shows an example of the configuration of the computation device according to the example embodiment.

FIG. 2 is a diagram that shows an example of a source program.

FIG. 3 is a diagram that shows an example of an intermediate representation.

FIG. 4 is a diagram that shows an example of an intermediate representation obtained by the optimization process performed by the optimization portion 230.

FIG. 5 is a diagram that shows an example of a source program that is not suitable for optimization processing.

FIG. 6 is a diagram that shows an example of the procedure in which the convertibility determination portion 231 detects the part of the intermediate representation that can be converted.

FIG. 7 is a diagram that shows a first example of a reference counter value.

FIG. 8 is a diagram that shows an example of a source program in which a function is directly described in the arguments of the function.

FIG. 9 is a diagram that shows a second example of a reference counter value.

FIG. 10 is a diagram that shows an example of a source program in which the assignment of values to global variables is performed.

FIG. 11 is a diagram that shows an example of a source program without a post-evaluation reference.

FIG. 12 is a diagram that shows an example of a source program with a post-evaluation reference.

FIG. 13 is a diagram that shows another example of the configuration of a computation device in accordance with the example embodiment.

FIG. 14 is a diagram that shows an example of the processing steps in the computing method according to the example embodiment.

FIG. 15 is a schematic block diagram showing the configuration of a computer in accordance with at least one example embodiment.

### EXAMPLE EMBODIMENT

The following is a description of example embodiments of the present invention, but the following example embodiments do not limit the scope of the claimed invention. Not all of the combinations of features described in the example embodiments are essential to the solution of the invention.

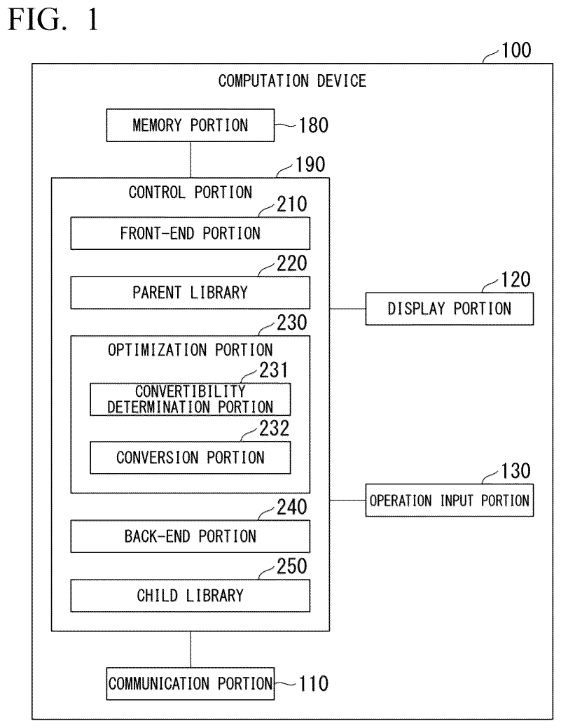

FIG. 1 is a diagram that shows an example of the configuration of the computation device according to the example embodiment. In the configuration shown in FIG. 1, a computation device 100 includes a communication portion 110, a display portion 120, an operation input portion 130, a memory portion 180, and a control portion 190. The control portion 190 has a front-end portion 210, a parent library 220, an optimization portion 230, a back-end portion 240, and a child library 250. The optimization portion 230 includes a convertibility determination portion 231 and a conversion portion 232.

The computation device 100 partially converts a source program, which is a program to be executed, such as a user program, into an intermediate representation and executes it. The computation device 100 may act as a runtime compiler (just-in-time compiler) to partially convert the source program into an intermediate representation for execution.

Converting a source program to an intermediate representation is also referred to as intermediate representationization or generation of an intermediate representation. Generally, a program is not deleted in the case where it is executed. For the computation device 100, it is conceivable to leave the part of the original source program that was converted to the intermediate representation without deleting it. However, the computation device 100 may delete the portion of the original source program that has been converted to an intermediate representation.

The computation device 100 is composed of a computer, such as a personal computer (PC).

The communication portion 110 communicates with other devices. For example, the communication portion 110 may communicate with another computer, such as a user's terminal device, to receive the source program. However, the method by which the computation device 100 obtains the source program is not limited to a specific method.

The display portion 120 has a display screen, such as a liquid crystal panel or light emitting diode (LED) panel, for example, to acquire various images. For example, the display portion 120 displays data and other information according to the display instructions in the source program.

The operation input portion 130 includes input devices such as a keyboard and mouse, for example, and accepts user operations. For example, the operation input portion 130 may accept a user operation that indicates execution of the source program. The display portion 120 may display an editor screen for inputting and editing source programs, and the operation input portion 130 may accept user operations for programming source programs.

The memory portion 180 stores various data. For example, the source program obtained by the communication portion 110 or the operation input portion 130 may be stored by the memory portion 180. The memory portion 180 is configured using the storage device provided by the computation device 100.

The control portion 190 controls the various parts of the computation device 100 to perform various processes. In particular, the control portion 190 executes the source program. As described above for the computation device 100, the control portion 190 partially converts the source program into an intermediate representation and executes it.

The functions of the control portion 190 are performed, for example, by the central processing unit (CPU) provided by the computation device 100, which reads and executes a program from the memory portion 180.

The computation device 100 may be equipped with an accelerator such as a graphics processing unit (GPU) in addition to the CPU, so that the functions of the control portion 190 are performed using the accelerator as well as the CPU. For example, the control portion 190 may convert the part of the source program that can be executed on the GPU into an intermediate representation for the GPU and execute it on the GPU, while the other part of the source program may be executed on the CPU by executing the source program.

The computation device 100 executes both the source program and the intermediate representation using a library. To execute an intermediate representation here means to perform operations, etc., that are represented in the intermediate representation format.

In the configuration of FIG. 1, the parent library 220 corresponds to an example of a library used to execute source programs, while the child library 250 corresponds to an example of a library used to execute intermediate representations.

The programming language of the parent library and source program is not limited to any particular one. The programming language of the child library and intermediate representation is also not limited to any particular one.

For example, the programming language of the parent library and source program may be one that provides a relatively wide variety of operations, etc., to make it easier for users to program. The programming language of the child library and intermediate representation may have some advantageous features over the execution of the source program, such as faster execution, while offering fewer operations and the like. Furthermore, for example, the programming language of the child library and intermediate representation may be a domain specific language (DSL) specific to the device that executes the intermediate representation, such as a GPU.

The front-end portion 210 partially converts the source program into an intermediate representation, with the resulting intermediate representation being executed by the back-end portion 240. In addition, the front-end portion 210 executes the portion of the source program that is not converted to an intermediate representation in the execution of the source program.

The front-end portion 210 is an example of an intermediate representation generation means.

An example of a portion of the source program that is not converted to an intermediate representation by the front-end portion 210 and is executed in the execution of the source program is a predetermined instruction that is scheduled to be executed in the source program among the instructions included in the source program. For example, the front-end portion 210 may execute display instructions (e.g., “print” statements) contained in the source program in the source program.

The intermediate representations generated by the front-end portion 212 are not executed immediately upon generation, but at the timing when the need to execute them arises. The execution of intermediate expressions in this case is also referred to as delayed execution.

For example, consider a case where a source program contains a sequence (sequence of instructions) to calculate the value of variable f and an instruction “print(f)” to print the value of variable f. In this case, the front-end portion 210 generates an intermediate representation of the sequence that computes the value of the variable f, but the intermediate representation is not executed at the time of generation. Then, at the timing when the instruction to display the value of variable f is executed in the execution of the source program, the back-end portion 240 executes an intermediate representation of the sequence to calculate the value of variable f, using the child library 250.

The process of determining the value of a variable or an operation is referred to as evaluating that variable or operation. The front-end portion 210 requests the back-end portion 240 to execute an intermediate representation for evaluation of variables or operations, etc.

The parent library 220 is a library that corresponds to the programming language of the source program. The front-end portion 210 executes the portion of the source program that is to be executed in the source program, using the parent library 220.

The optimization portion 230 performs optimization on the intermediate representation generated by the front-end portion 210. For example, the computation device 100 may function as a domain-specific compiler that compiles for a specific domain, such as matrix computation in a source program, and the optimization portion 230 may perform optimization processing on intermediate representations using knowledge about the specific domain.

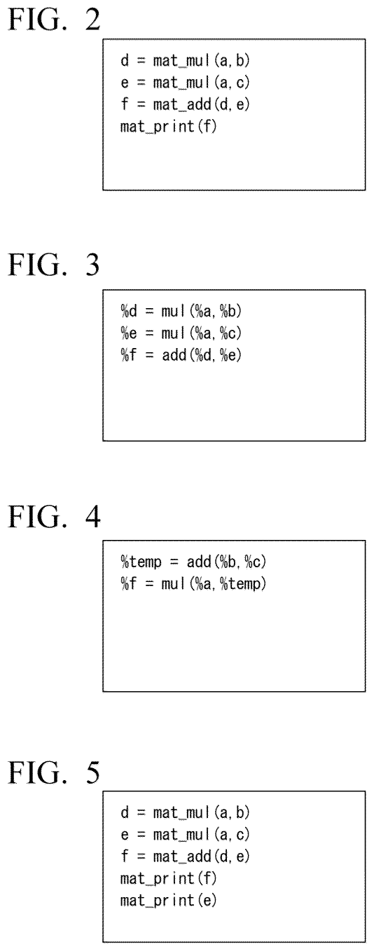

FIG. 2 shows an example of a source program. FIG. 2 shows a program that performs the matrix calculation “f=(a+b)*(a+c)” and displays the value of the matrix f. The “*” denotes matrix multiplication. The “+” represents matrix addition.

“mat_mul” represents matrix multiplication, and “mat_add” represents matrix addition. “mat_mul”, “mat_add” and “mat print” shall all be provided by the parent library 220.

The variables “a,” “b,” and “c” all represent matrices, and their values are assumed to be fixed by the time the program shown in FIG. 2 is executed. The variables “d,” “e,” and “f” also represent matrices, respectively.

“mat_print(f)” indicates that the value of variable f is to be printed.

FIG. 3 is a diagram that shows an example of an intermediate representation. FIG. 3 shows an example where the intermediate representation obtained by converting the source program shown in FIG. 2 is represented in the form of a program by the front-end portion 210. An intermediate representation in the form of a program is also called an intermediate program or intermediate code.

The front-end portion 210 may generate an intermediate representation of the tree structure that shows the reference relationship of the data, and output the portion of the intermediate representation of the tree structure that corresponds to the calculation of the desired value in an intermediate code.

In the source program shown in FIG. 2, “mat_print(f)” shall be executed by the front-end portion 210 in the source program. The front-end portion 210 converts “d=mat_mul(a, b)”, “e=mat_mul(a, c)”, and “f=mat_add(d, e)” in the source program shown in FIG. 2 into intermediate representations. FIG. 3 shows an intermediate representation that performs the matrix calculation “f=(a+b)*(a+c)”.

In the example in FIG. 3, “mul” represents matrix multiplication in the intermediate representation, corresponding to “mat_mul” in the source program. “add” represents the addition of matrices in the intermediate representation, corresponding to “mat add” in the source program. Both “mul” and “add” shall be provided by the child library 250.

“%a” represents the variable corresponding to variable a in FIG. 2. “%b” represents the variable corresponding to variable b in FIG. 2. “%c” represents the variable corresponding to variable c in FIG. 2. “%d” represents the variable corresponding to variable d in FIG. 2. “%e” represents the variable corresponding to variable e in FIG. 2. “%f” represents the variable corresponding to variable f in FIG. 2.

FIG. 4 is a diagram showing an example of an intermediate representation obtained by the optimization process performed by the optimization portion 230. FIG. 4 shows an example of an intermediate representation obtained by the optimization portion 230 performing optimization processing on the intermediate representation shown in FIG. 3.

FIG. 4 shows the intermediate representation for performing the matrix calculation “f=a*(b+c)”. “%temp=add(%b, %c)” adds the variables “%b” and “%c” which represent matrices, and inputs the result of the calculation into the variable “%temp”. “%f=mul (%a, %temp)” multiplies the variables “%a” and “%temp” which represent matrices, and inputs the result into the variable “%f”.

The intermediate representation shown in FIG. 4 can be said to be an optimization of the intermediate representation shown in FIG. 3 by the optimization portion 230 using knowledge about the domain of matrices, in which the distributive law holds for matrices. The intermediate representation shown in FIG. 4 has one less multiplication than the intermediate representation shown in FIG. 3.

The convertibility determination portion 231 detects a portion of the intermediate representation generated by the front-end portion 210 that can be converted by optimization. The convertibility determination portion 231 corresponds to an example of a convertibility determination means.

Here, depending on the data reference relationship in the intermediate representation, there may be cases where the optimization process cannot be applied to the intermediate representation, or where the desired effect cannot be obtained even if the optimization process is applied.

FIG. 5 is a diagram showing an example of a source program that is not suitable for optimization processing. In the source program shown in FIG. 5, “mat_print(e)” is added after the source program shown in FIG. 2, which indicates that the value of the variable e is to be displayed.

In the source program shown in FIG. 2, only the value of the variable f is to be displayed, whereas in the source program shown in FIG. 5, the value of the variable e is also to be displayed in addition to the value of the variable f.

Here, let us consider a case where the intermediate representation shown in FIG. 3 is generated for the source program shown in FIG. 5 and optimized to produce the intermediate representation shown in FIG. 4. In this case, in the intermediate representation shown in FIG. 4, “%e=mul(%a, %c)” is missing, and if “mat_print(e)” is executed in the source program in FIG. 5, the value of the variable e cannot be obtained.

Therefore, it is necessary to either treat “mat_print(e)” as an error, or to insert the calculation “%e=mul(%a, %c)” into the optimized intermediate representation.

If “mat_print(e)” is treated as an error, it would be a burden for the user, as the user would not be able to display the value of the variable e as desired, or it would be necessary to impose restrictions on how the program is written so that errors do not occur.

If the calculation “%e=mul(%a, %c)” is inserted into the intermediate representation after optimization, the effect of reducing the number of calculations will not be obtained, and the processing time becomes longer due to the time it takes to rewrite the intermediate representation during optimization.

Although FIG. 5 shows an example in which a variable is referenced in the display instruction “mat_print(e)”, the same applies to the case in which a variable is referenced in a calculation rather than in an instruction. For example, if the source program shown in FIG. 5 contains the operation “g=add(e, e)” instead of “mat_print(e)” and the value of the variable g is evaluated, optimizing the intermediate representation will result in problems similar to those described above.

Therefore, the convertibility determination portion 231 detects a portion of the intermediate representation generated by the front-end portion 210 that will not cause the inconvenience of being unable to reference the above-mentioned data even if conversion such as optimization is performed. A portion of the intermediate representation that can be converted without causing the inconvenience of being unable to reference data as described above is referred to as a portion that can be converted to another operation, or simply as a convertible portion.

The specific process performed by the convertibility determination portion 231 will be described later.

The conversion portion 232 optimizes a portion of the intermediate representation generated by the front-end portion 210 that the convertibility determination portion 231 detects as a convertible portion. The optimization performed by the conversion portion 232 is not limited to a specific type.

If the convertibility determination portion 231 cannot detect a convertible part, and if there is no optimization that can be applied to a part that the convertibility determination portion 231 detects as a convertible part, the conversion portion 232 does not convert the intermediate representation.

The back-end portion 240 executes the intermediate representation. As described above, at then point in time when the front-end portion 210 generates an intermediate representation, the back-end portion 240 does not execute the intermediate representation. In the case where the front-end portion 210 executes a source program and requests the back-end portion 240 to execute an intermediate representation in order to evaluate variables or operations, etc., the back-end portion 240 executes the intermediate representation in response to the request from the front-end portion 210.

The child library 250 is a library that corresponds to the programming language of the intermediate code. The back-end portion 240 obtains the intermediate representation in the form of intermediate code from the optimization portion 230 and executes the obtained intermediate representation using the child library 250.

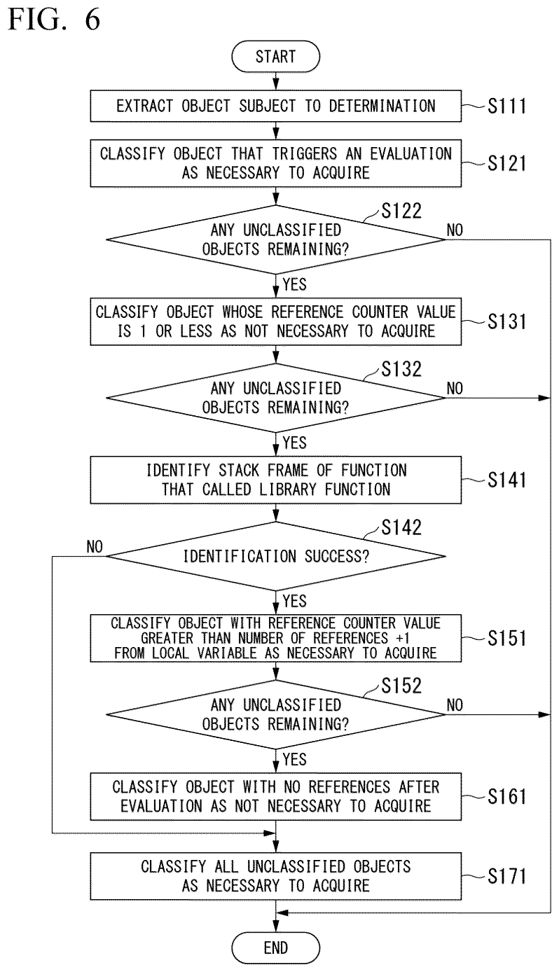

FIG. 6 is a diagram showing an example of a procedure for the convertibility determination portion 231 to detect a convertible part of an intermediate representation. The convertibility determination portion 231 performs a process of detecting convertible parts, targeting objects in the source program.

An object here is an abstract representation of data that appears during the execution of a program, or a storage area for that data. Selecting an object in a source program can be viewed as selecting a variable in an intermediate representation that corresponds to that object, and further, as selecting an operation that computes the value of that variable.

Therefore, it can be said that the convertibility determination portion 231 detects convertible parts, targeting objects in the source program, and thereby detects operations that can be converted to other operations among the operations included in the intermediate representation. The operations that can be converted to other operations correspond to the above-mentioned parts that can be converted to other operations.

Here, in the case where the front-end portion 210 executes the source program, at the time of calculation in the source program (in the case where a library function of the parent library 220 is called), an intermediate representation is generated without actually performing a calculation. For this reason, the front-end portion 210 assigns a Future type object, which represents an intermediate state, to data such as variables handled during the execution of the source program.

The Future type is expressed, for example, as “class Future {op, result}”. The actual data is stored in “result”. Until the actual operation is performed, “result” is undefined. “op” indicates information about the instruction for calculating “result”.

For example, “op” indicates the name of an operation (type of operation) such as “mat_mul” or “mat_add” in the source program shown in FIG. 2.

### Step S111

The convertibility determination portion 231 selects an object that is subject to the determination as to whether it is convertible or not from among the objects in the source program. The convertibility determination portion 231 selects an object indicating an output variable subject to the determination of as to whether or not it is convertible. The output variable here is a variable that indicates a value obtained by executing a program.

In the case of the source program shown in FIG. 2, the objects indicating the variables d, e, and f shown on the left side of the equation representing the assignment statement are examples of objects subject to the determination as to whether or not they can be converted.

In the following, an object that indicates a variable will also be represented by the name of that variable. For example, in the source program shown in FIG. 2, an object representing a variable a is also written as an object a. An object representing a variable b is also written as object b. An object representing a variable c is also written as an object c. An object representing a variable d is also written as an object d. An object representing a variable e is also written as an object e. An object representing a variable e is also written as an object e.

In the case of the source program shown in FIG. 2, the convertibility determination portion 231 selects objects d, e, and f as objects subject to determination. The convertibility determination portion 231 classifies the objects selected as subjects of determination in Step S111 into objects whose values need to be acquired at the time of evaluation and objects whose values do not need to be acquired at the time of evaluation.

Objects whose values need to be obtained during evaluation correspond to parts of the intermediate representation that cannot be converted to other representations. The necessity of acquiring a value at the time of evaluation is also referred to as the acquisition necessity.

Objects whose values do not need to be acquired during evaluation correspond to parts of the intermediate representation that can be converted to other representations. The fact that no value needs to be acquired during evaluation is also referred to as “no acquisition required.”

In the following, examples of the classification status of objects by the convertibility determination portion 231 are indicated as target [ ], necessary [ ], unnecessary [ ]. Within the brackets of target [ ], the convertibility determination portion 231 indicates by variable name the unclassified objects, among the objects selected as being subjects for determination regarding the necessity of obtaining their values during evaluation. Within the brackets of necessary[ ], the convertibility determination portion 231 indicates by variable name the objects classified as necessary to acquire. Within the brackets of unnecessary[ ], the convertibility determination portion 231 indicates by variable name the objects classified as not necessary to acquire.

In the case of the source program shown in FIG. 2, the classification status of objects when the convertibility determination portion 231 executes the process of Step S111 is expressed as follows: target [d, e, f], necessary [ ], unnecessary [ ].

After Step S111, the process proceeds to Step S121.

### Step S121

The convertibility determination portion 231 classifies an object that triggers an evaluation as one that needs to be acquired. An object that triggers an evaluation is an object whose value is needed during the execution of the source program. The front-end portion 210 causes the back-end portion 240 to execute the intermediate representation to determine the value of the object. In the case of the source program shown in FIG. 2, the object f indicating the variable f referenced by “mat_print(f)” corresponds to an example of an object that triggers evaluation.

In the case of the source program shown in FIG. 2, the classification state of the objects when the convertibility determination portion 231 executes the process of Step S121 is expressed as follows: target [d, e], necessary [f], unnecessary [ ].

After Step S121, the process proceeds to Step S122.

### Step S122

The convertibility determination portion 231 determines whether or not there are any unclassified objects remaining.

If the convertibility determination portion 231 determines that an unclassified object remains (Step S122: YES), the process proceeds to Step S131. On the other hand, if it is determined that there are no unclassified objects remaining (Step S122: NO), the convertibility determination portion 231 ends the process of FIG. 6.

### Step S131

The convertibility determination portion 231 acquires the value of the reference counter of each object to be determined, and classifies an object whose reference counter value is 1 or less as one not requiring acquisition.

After Step S131, the process proceeds to Step S132.

The process in Step S131 will be further described.

A reference counter is provided for each object and counts the number of times that object is referenced in the source program. Specifically, the reference counter counts the number of pointers attached to an object.

In programming languages that use reference counters, reference counters are used to manage the lifetime of objects. In particular, the memory of an object whose reference counter reaches zero is freed.

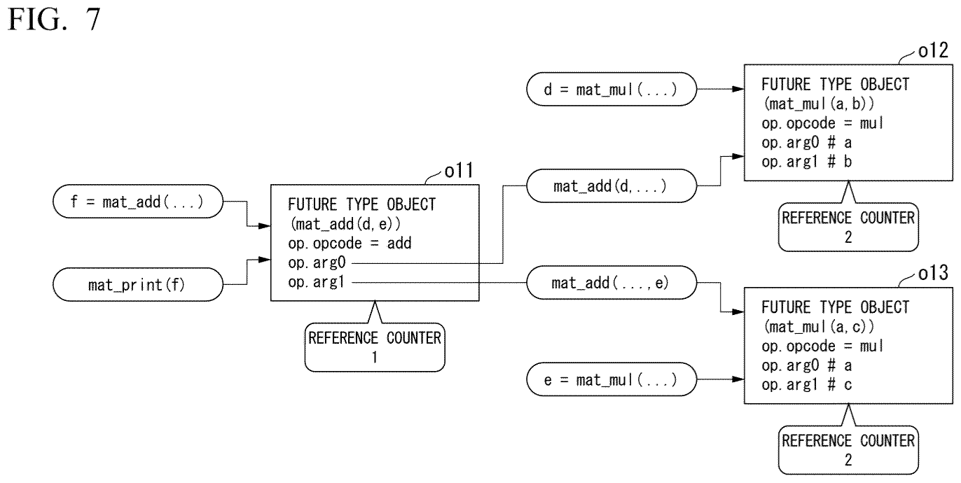

FIG. 7 is a diagram showing a first example of the value of the reference counter. FIG. 7 shows an example of the values of a reference counter in the source program shown in FIG. 2.

Object o11 is a Future type object that indicates the calculation result of “mat_add(d, e)”.

In the explanation of the process performed by the convertibility determination portion 231, the object o11 is represented by the variable name “f”.

In the source program shown in FIG. 2, the object o11 is referenced from the variable f in both “f=mat_add(d, e)” and “mat_print(f)”. In the example of FIG. 7, the reference counter value of object o11 is 1.

Object 012 is a Future type object that indicates the calculation result of “mat_mul(a, b)”.

In the explanation of the process performed by the convertibility determination portion 231, the object 012 is represented by the variable name “d”.

In the source program shown in FIG. 2, object 012 is referenced from variable d in “d=mat_mul(a, b)” and referenced from the argument of “f=mat_add(d, e)” (variable arg0 in the example of FIG. 7). In the example of FIG. 7, the reference counter value of object o12 is 2.

Object 013 is a Future type object that indicates the calculation result of “mat_mul(a, c)”.

In the explanation of the process performed by the convertibility determination portion 231, the object 013 is represented by the variable name “e”.

In the source program shown in FIG. 2, object 013 is referenced from variable e in “e=mat_mul(a, c)” and referenced from the argument of “f=mat_add(d, e)” (variable arg1 in the example of FIG. 7). In the example of FIG. 7, the reference counter value of object 013 is 2.

The convertibility determination portion 231 classifies, from among the unclassified objects, objects whose reference counter value is 1 or less as objects not requiring acquisition. On the other hand, the convertibility determination portion 231 leaves the object whose reference counter value is 2 or more as unclassified in the process of Step S131.

The reason why 1 is used as the criterion instead of 0 is that internal references of an object are taken into consideration.

In the case of the source program shown in FIG. 2, the classification status of the objects when the convertibility determination portion 231 executes the process of Step S131 is as follows: target [d, e], necessary [f], unnecessary [ ].

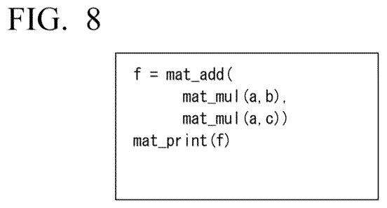

FIG. 8 is a diagram showing an example of a source program in which functions are directly written in the arguments of the functions.

In the source program shown in FIG. 2, the calculation result of “mat_mul(a, b)” is assigned to the variable d, and the calculation result of “mat_mul(a, c)” is assigned to the variable e. Then, in the calculation of “mat_add(e, f)”, the values of the variables d and e are read out.

In contrast, in the source program shown in FIG. 8, “mat_mul(a, b)” and “mat_mul(a, c)” are written directly as arguments to “mat_add” as in “mat_add(mat_mul(a, b), mat_mul(a, c)).” In the source program shown in FIG. 8, the values of “mat_mul(a, b)” and “mat_mul(a, c)” are used as arguments of “mat_add” to perform the calculation of this “mat_add”.

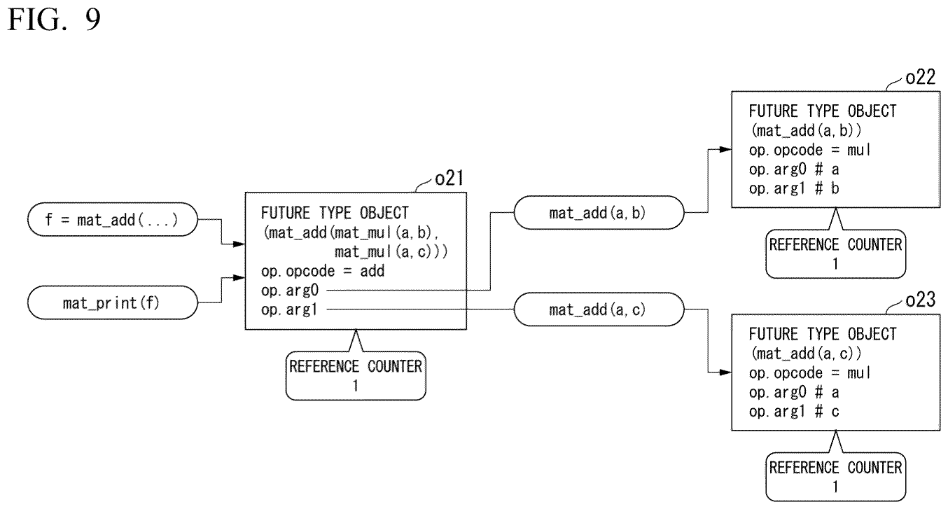

FIG. 9 is a diagram showing a second example of the value of the reference counter. FIG. 9 shows an example of the values of a reference counter in the source program shown in FIG. 8.

Object o21 is a Future type object that indicates the calculation result of “mat_add(mat_mul(a, b), mat_mul(a, c))”.

In the source program shown in FIG. 8, the object 02 is referenced from the variable f in both “f=mat_add(mat_mul(a, b), mat_mul(a, c))” and “mat_print(f)”. In the example of FIG. 9, the reference counter value of object o21 is 1.

Object 022 is a Future type object that indicates the calculation result of “mat_mul(a, b)”.

In the source program shown in FIG. 8, one instance of retrieving the value of “mat_mul(a, b)” in the expression “f=mat_add(mat_mul(a, b), mat_mul(a, c))” is counted as a reference of object 022. This reference is represented in the example of FIG. 9 as a reference from the variable arg0. In the example of FIG. 9, the reference counter value of object o22 is 1.

Object 023 is a Future type object that indicates the calculation result of “mat_mul(a, c)”.

In the source program shown in FIG. 8, one instance of retrieving the value of “mat_mul(a, c)” in the expression “f=mat_add(mat_mul(a, b), mat_mul(a, c))” is counted as a reference of object 023. This reference is represented in the example of FIG. 9 as a reference from the variable arg1. In the example of FIG. 9, the reference counter value of object o23 is 1.

In the case where the reference counter value is 1, as in the case of object 022, even if the intermediate representation corresponding to the part where the reference is made is rewritten, the reference will not be made elsewhere, and the above-mentioned inconvenience will not occur. Therefore, for an object whose reference counter value is 1 in Step S103 of FIG. 6, the convertibility determination portion 231 can classify it as an object not requiring acquisition without needing to perform Step S104 and the subsequent processes.

### Step S132

The convertibility determination portion 231 determines whether or not there are any unclassified objects remaining.

If the convertibility determination portion 231 determines that an unclassified object remains (Step S132: YES), the process proceeds to Step S141. On the other hand, if it is determined that there are no unclassified objects remaining (Step S132: NO), the convertibility determination portion 231 ends the process of FIG. 6.

### Step S141

The convertibility determination portion 231 performs a process of identifying the stack frame of the function that called the instruction that triggered the evaluation.

Here, it is assumed that the source program is written in such a way that a main program calls a function, and if a function is called, information about the function to be called is stored in a stack. It is also assumed that information about the main program is initially stored in the stack. A stack frame is information about the main program and individual functions stored on the stack.

In the source program shown in FIG. 2, “mat_print(f)” corresponds to an example of an instruction that triggers evaluation. The function or main program including the source program shown in FIG. 2 corresponds to an example of the function that called the instruction that triggered the evaluation.

After Step S141, the process proceeds to Step S142.

### Step S142

The convertibility determination portion 231 determines whether or not the stack frame has been identified in the process of Step S141.

If the convertibility determination portion 231 determines that the stack frame has been identified (Step S142: YES), the process proceeds to Step S151. On the other hand, if the convertibility determination portion 231 determines that the stack frame has not been identified (Step S142: NO), the process proceeds to Step S171.

### Step S151

The convertibility determination portion 231 classifies an object with a reference counter value greater than the number of object references +1 from the local variable in the function that called the instruction that triggered the evaluation, as indicated in the stack frame, as an object that needs to be acquired.

In the case of the source program shown in FIG. 2, there are no objects classified as necessary to acquire in Step S152, and the classification status of the objects when the convertibility determination portion 231 executes the process of Step S131 is as follows: target [d, e], necessary [f], unnecessary [ ].

After Step S151, the process proceeds to Step S152.

The process in Step S151 shall be further described.

As described above, a stack frame is information about one function that is stored in the stack if a function is called. The stack frame stores the local variables of the called function, the base address (ebp) of the stack frame of the previous function (the function on the calling side), the return address of the called function, the arguments of the called function, and the like.

In the processing in Step S151, the convertibility determination portion 231 uses the information of the local variables contained in the stack frame to determine whether the reference to an object from a variable within a function is a reference from a local variable or a reference from a global variable. Then, for each of the unclassified objects, the convertibility determination portion 231 compares the value obtained by adding 1 to the number of references from the local variable with the value of the reference counter.

The reason why one is added to the number of references from the local variable is to take into consideration internal references to the object.

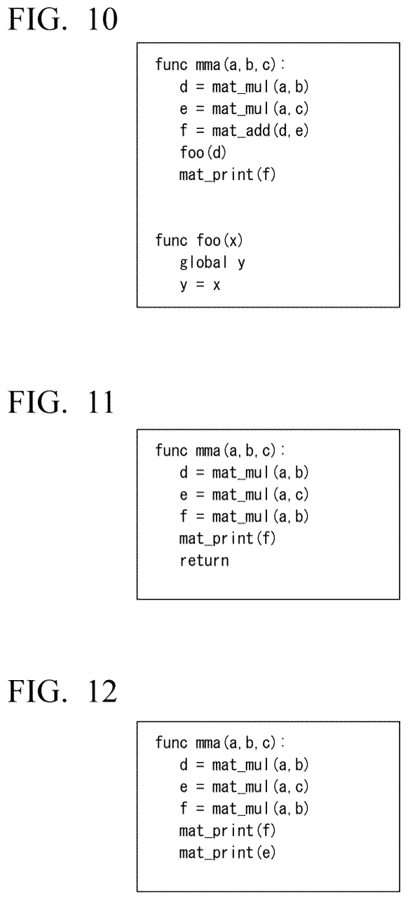

FIG. 10 is a diagram showing an example of a source program in which values are substituted into global variables.

In the example of FIG. 10, a function “mma” and a function “foo” are shown.

Looking at the variable d, the value of the calculation result of “mat_mul(a, b)” is assigned to the variable d in “d=mat_mul(a, b)” in the function “mma”. Also, the variable d is passed to the function foo in “foo(d)”.

The variable d passed to the function “foo” is assigned to the global variable y within the function “foo”.

In addition, in the function “mma”, references to object d appear in three places: “d=mat_mul(a, b)”, “f=mat_add(d, e)”, and “foo(d)”. The reference counter value of object d becomes 3.

In the function “mma”, references to the object e appear in two places: “e=mat_mul(a, c)” and “f=mat_add(d, e)”. The reference counter value of object e becomes 2.

In the function “mma”, references to object f appear in two places: “f=mat_add(d, e)” and “mat_print(f)”. The reference counter value of object f becomes 2.

Comparing the reference counter value with the above values calculated with reference to the stack frame, for object d, the reference counter value is 3 and the value calculated with reference to the stack frame is 1. Since the former value is greater than the latter value, it can be determined that the reference to object d from the variable may include a reference from a global variable. In this case, there is a possibility that the object d is referenced outside the function “mma”, and the convertibility determination portion 231 classifies the object d as one that needs to be acquired.

On the other hand, for object e, the value of the reference counter is 2, while the value calculated by referencing the stack frame is also 2. Since the two values are equal, it can be determined that the reference to object e from the variable is a reference from a local variable. In this case, the convertibility determination portion 231 leaves the object e unclassified in Step S151.

For object f as well, the value of the reference counter is 2, while the value calculated by referencing the stack frame is also 2. Since the two values are equal, it can be determined that the reference to object e from the variable is a reference from a local variable. In this case, the convertibility determination portion 231 leaves the object f unclassified in Step S151.

### Step S152

The convertibility determination portion 231 determines whether or not there are any unclassified objects remaining.

If the convertibility determination portion 231 determines that an unclassified object remains (Step S152: YES), the process proceeds to Step S161. On the other hand, if it is determined that there are no unclassified objects remaining (Step S152: NO), the convertibility determination portion 231 ends the process of FIG. 6.

### Step S161

The convertibility determination portion 231 determines, for each of the unclassified objects, whether or not there is a reference after evaluation from the source code of the function that called the function to be evaluated and the instruction sequence. The convertibility determination portion 231 classifies an object that is determined to have no references after the evaluation as an object not requiring acquisition.

In the case of the source program shown in FIG. 2, neither object d nor object e has a reference after “mat_print(f)”. As a result, the convertibility determination portion 231 classifies the objects d and e as objects not requiring acquisition. The classification status of the objects when the convertibility determination portion 231 executes the process of Step S161 is expressed as follows: target [ ], necessary [f], unnecessary [d, e].

After Step S161, the process proceeds to Step S171.

The process in Step S161 shall be further described.

FIG. 11 is a diagram showing an example of a source program with no references after evaluation.

In the example shown in FIG. 11, it is assumed that objects d and e remain as unclassified objects.

In the example shown in FIG. 11, the instruction to be evaluated, “mat_print(f),” is immediately followed by “return,” and neither object d nor object e is referenced after evaluation. In this case, the convertibility determination portion 231 classifies the objects d and e as objects not requiring acquisition.

FIG. 12 is a diagram showing an example of a source program with a post-evaluation reference.

In the example shown in FIG. 12, it is assumed that object d remains as an unclassified object.

In the example shown in FIG. 12, the instruction to be evaluated, “mat_print(f)”, is followed by “mat_print(e)”, in which the object e is referenced. In this case, the convertibility determination portion 231 leaves the object e unclassified.

In addition, the convertibility determination portion 231 classifies the objects that remain unclassified in the processes up to Step S161 as objects that need to be acquired in Step S171.

In Step S161, the convertibility determination portion 231 also leaves the unclassified object as unclassified if the evaluated code cannot be analyzed, if the analysis would be costly, or if the source code cannot be accessed.

### Step S171

The convertibility determination portion 231 classifies all the objects that remain unclassified as objects that need to be acquired. For objects for which it was not possible to determine whether a result was necessary, the result is determined to be necessary on the safe side to avoid any inconvenience such as an error.

After Step S171, the convertibility determination portion 231 ends the process of FIG. 6.

As described above, the front-end portion 210 generates an intermediate representation that corresponds to a part of the source program, which is the program to be executed. The convertibility determination portion 231 determines that an operation which is among the operations indicated by the intermediate representation, and for which the object corresponding to the result of the operation is referenced once or less frequently in the source program, can be converted to another operation. The conversion portion 232 performs processing to convert the intermediate representation based on the result of the determination as to whether conversion to another operation is possible. The back-end portion 240 executes the intermediate representation after the processing by the conversion means.

The computation device 100 can determine whether an operation indicated by the intermediate representation can be converted to another operation based on the relatively simple process of counting the number of times an object is referenced in a source program. In this respect, the computation device 100 can detect the part of the intermediate representation that can be converted to another operation with a relatively small load.

In addition, the convertibility determination portion 231 counts, for each object representing data handled in the execution of the source program, the number of times the result of an operation in the source program is referenced, using a reference counter used to manage the lifetime of the object.

According to the computation device 100, it is possible to determine whether or not an operation indicated by the intermediate representation can be converted to another operation by using a reference counter provided for managing objects. In this respect, according to the computation device 100, there is no need to provide a separate mechanism for counting the number of times an object is referenced.

In addition, the convertibility determination portion 231 determines that an operation indicated by the intermediate representation and an operation in the source program for which the object corresponding to the result of the operation is referenced more than once and the number of times that the object is referenced is greater than the number of times that the object is referenced from a local variable plus one, cannot be converted to another operation.

According to the computation device 100, even for a source program that uses global variables, it is possible to determine whether or not an operation indicated by the intermediate representation can be converted to another operation.

Furthermore, the convertibility determination portion 231 refers to the stack frame of a function in the source program to obtain information indicating local variables in that function.

According to the computation device 100, information indicating whether a variable is a local variable or a global variable can be obtained by the relatively simple process of referencing the stack frame.

In addition, if the convertibility determination portion 231 cannot identify the stack frame of the function that called the instruction that triggers the execution of the intermediate representation in the source program, it determines that the operation indicated by the intermediate representation and an operation in which an object corresponding to the result of that operation is referenced more than once in the source program cannot be converted to another operation.

According to the computation device 100, if desired information cannot be obtained from the stack frame, it is possible to make a determination on the safe side, such as determining that a portion of the intermediate representation cannot be converted to another operation.

In addition, the convertibility determination portion 231 determines that an operation in a function that calls an instruction that triggers the execution of an intermediate representation in a source program, which corresponds to an object that is not referenced after the instruction is called, can be converted to another operation.

According to the computation device 100, it is possible to determine in more detail whether or not an operation indicated by an intermediate representation can be converted to another operation.

Furthermore, the convertibility determination portion 231 determines that an operation indicated by the intermediate representation, for which it is not yet determined whether it can be converted to another operation, cannot be converted to another operation.

According to the computation device 100, it is possible to make a conservative determination such that, for an operation whose convertibility to another operation is undetermined, it is determined that it cannot be converted to another operation.

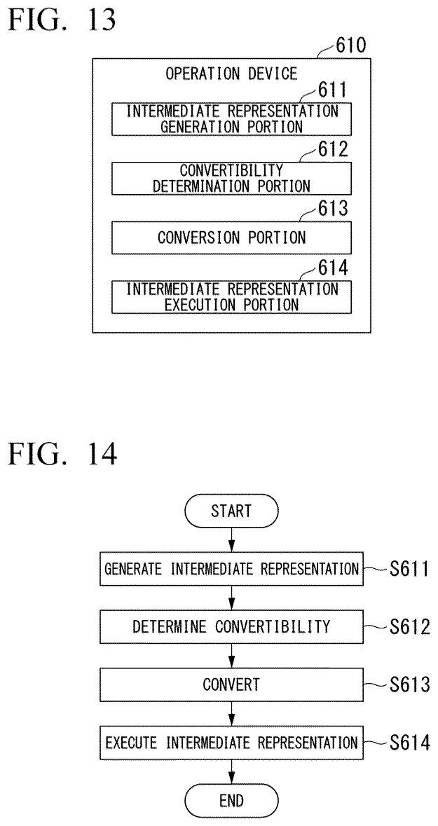

FIG. 13 is a diagram illustrating another example of the configuration of the computation device according to the example embodiment. In the configuration shown in FIG. 13, a computation device 610 includes an intermediate representation generation portion 611, a convertibility determination portion 612, a conversion portion 613, and an intermediate representation execution portion 614.

With this configuration, the intermediate representation generation portion 611 generates an intermediate representation that corresponds to a part of the source program, which is the program to be executed.

The convertibility determination portion 612 determines that an operation which is among the operations indicated by the intermediate representation, and for which the object corresponding to the result of the operation is referenced once or less frequently in the source program, can be converted to another operation. The conversion portion 613 performs processing to convert the intermediate representation based on the result of the determination as to whether conversion to another operation is possible. The intermediate representation execution portion 614 executes the intermediate representation processed by the conversion portion 613.

The intermediate representation generation portion 611 corresponds to an example of an intermediate representation generation means. The convertibility determination portion 612 corresponds to an example of a convertibility determination means. The conversion portion 613 corresponds to an example of a conversion means. The intermediate representation execution portion 614 corresponds to an example of an intermediate representation execution means.

The computation device 610 can determine whether an operation indicated by the intermediate representation can be converted to another operation based on the relatively simple process of counting the number of times an object is referenced in the source program. In this respect, the computation device 610 can detect the part of the intermediate representation that can be converted to another operation with a relatively small load.

FIG. 14 is a diagram illustrating an example of a processing procedure in the computation method according to the example embodiment. The computation method shown in FIG. 14 includes generating an intermediate representation (Step S611), determining whether conversion is possible (Step S612), performing the conversion (Step S613), and executing the intermediate representation (Step S614).

In generating an intermediate representation (Step S611), the computer generates an intermediate representation corresponding to a part of a source program, which is a program to be executed.

In determining whether conversion is possible (Step S612), a computer determines that an operation which is among the operations indicated by the intermediate representation, and for which the object corresponding to the result of the operation is referenced once or less frequently in the source program, can be converted to another operation.

In performing conversion (Step S613), the computer performs a process to convert the intermediate representation based on the result of the determination as to whether or not conversion to another operation is possible.

Executing the intermediate representation (Step S614) involves the computer executing the intermediate representation after the process to convert the intermediate representation.

In the computation method shown in FIG. 14, it is possible to determine whether or not an operation indicated by an intermediate representation can be converted to another operation based on the relatively simple process of counting the number of times an object is referenced in the source program. In this respect, the calculation method shown in FIG. 14 makes it possible to detect the part of the intermediate representation that can be converted to another operation with a relatively small load.

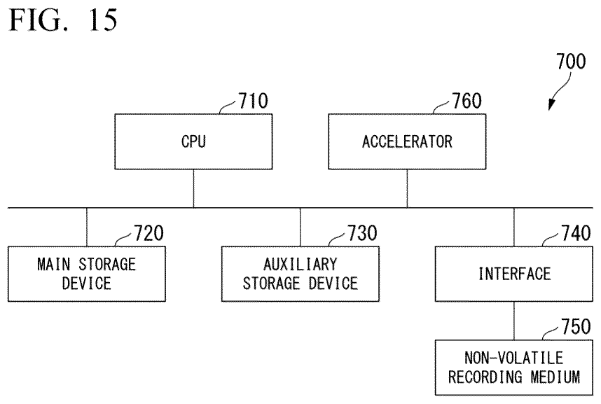

FIG. 15 is a schematic block diagram illustrating a configuration of a computer according to at least one example embodiment.

In the configuration shown in FIG. 15, a computer 700 includes a CPU 710, a main storage device 720, an auxiliary storage device 730, an interface 740, and a non-volatile recording medium 750.

Any one or more of the above computation device 100 and computation device 610, or parts thereof, may be implemented in the computer 700. In that case, the operations of each of the above-mentioned processing portions are stored in the auxiliary storage device 730 in the form of a program. The CPU 710 reads the program from the auxiliary storage device 730, extracts it to main storage device 720, and executes the above processing according to the program. The CPU 710 also reserves a memory area in the main storage device 720 corresponding to each of the above-mentioned memory portions according to the program. Communication between each device and other devices is performed by the interface 740, which has a communication function and communicates according to the control of the CPU 710.

If the computation device 100 is implemented in the computer 700, the operation of the control portion 190 and the various portions thereof is stored in the auxiliary storage device 730 in the form of a program. The CPU 710 reads the program from the auxiliary storage device 730, extracts it to main storage device 720, and executes the above processing according to the program.

The CPU 710 also reserves a storage area in the main storage device 720 for the storage portion 180 according to the program. Communication between the computation device 100 and other devices is performed by the interface 740, which has a communication function and operates according to the control of the CPU 710. Interaction between the computation device 100 and the user is performed by the interface 740, which is equipped with a display and input devices and displays various images and accepts user operations according to the control of the CPU 710.

If the computation device 610 is implemented in the computer 700, the operations of the intermediate representation generation portion 611, the convertibility determination portion 612, the conversion portion 613, and intermediate representation execution portion 614 are stored in the auxiliary storage device 730 in program form. The CPU 710 reads the program from the auxiliary storage device 730, extracts it to main storage device 720, and executes the above processing according to the program.

The CPU 710 also reserves a storage area in the main memory 720 for processing by the computation device 610 according to the program. Communication between the computation device 610 and other devices is performed by the interface 740, which has a communication function and operates according to the control of the CPU 710. Interaction between the computation device 610 and the user is performed by the interface 740, which is equipped with a display and input devices and displays various images and accepts user operations according to the control of the CPU 710.

Any one or more of the above programs may be recorded on a non-volatile recording medium 750. In this case, the interface 740 may read the program from the non-volatile recording medium 750. The CPU 710 may then directly execute the program read by the interface 740 or save it once in the main storage device 720 or auxiliary storage device 730 before execution.

A program for executing all or part of the processes performed by the computation device 100 and the computation device 610 may be recorded on a computer-readable recording medium, and the program recorded on this recording medium may be loaded into a computer system to perform the processing of each portion. The term “computer system” here shall include an operating system (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The aforementioned program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs and the like to the extent that they do not depart from the gist of this invention.

Some or all of the above example embodiments may also be described as, but not limited to, the following supplementary notes.

### (Supplementary Note 1)

A computation device comprising:
an intermediate representation generation means that generates an intermediate representation corresponding to a part of a source program, which is a program to be executed;
a convertibility determination means that determines that, among operations indicated by the intermediate representation, an operation a number of times of an object for which is referenced in the source program is one or less is convertible to another operation, the object corresponding to a result of the operation;
a conversion means that performs a process for converting the intermediate representation, based on a result of determining whether or not the operation is convertible to another operation; and
an intermediate representation execution means that executes the intermediate representation after the process is performed by the conversion means.

### (Supplementary Note 2)

The computation device according to supplementary note 1, wherein the convertibility determination means counts, for each object representing data handled in execution of the source program, a number of times a result of an operation in the source program is referenced, using a reference counter used to manage a lifetime of the object.

### (Supplementary Note 3)

The computation device according to supplementary note 1 or 2, wherein the convertibility determination means determines that an operation a number of times of an object for which is referenced in the source program is greater than a number which is obtained by adding one to a number of times that the object is referenced from a local variable is not convertible to another operation, among operations that are indicated by the intermediate representation and a number of times of an object for which is more than once, the object corresponding to a result of the operation.

### (Supplementary Note 4)

The computation device according to supplementary note 3, wherein the convertibility determination means refers to a stack frame of a function in the source program to obtain information indicating a local variable in the function.

### (Supplementary Note 5)

The computation device according to supplementary note 4, wherein the convertibility determination means, in the case of not being able to identify a stack frame of a function that called an instruction that triggers execution of the intermediate representation in the source program, determines that an operation that is indicated by the intermediate representation and a number of times of an object for which is referenced in the source program is more than once is not convertible to another operation, the object corresponding to a result of the operation.

### (Supplementary Note 6)

The computation device according to supplementary note 5, wherein the convertibility determination means determines that an operation in a function that calls an instruction that triggers execution of the intermediate representation in a source program, which corresponds to an object that is not referenced after the instruction is called, is convertible to another operation.

### (Supplementary Note 7)

The computation device according to supplementary note 6, wherein the convertibility determination means determines that an operation indicated by the intermediate representation, for which it is not yet determined whether it is convertible to another operation, is not convertible to another operation.

### (Supplementary Note 8)

A computation method executed by a computer, comprising:
generating an intermediate representation corresponding to a part of a source program, which is a program to be executed;
determining that, among operations indicated by the intermediate representation, an operation a number of times of an object for which is referenced in the source program is one or less is convertible to another operation, the object corresponding to a result of the operation;
performing a process for converting the intermediate representation, based on a result of determining whether or not the operation is convertible to another operation; and executing the intermediate representation after the process for converting the intermediate representation.

### (Supplementary Note 9)

A recording medium that records a program for causing a computer to execute: generating an intermediate representation corresponding to a part of a source program, which is a program to be executed;
determining that, among operations indicated by the intermediate representation, an operation a number of times of an object for which is referenced in the source program is one or less is convertible to another operation, the object corresponding to a result of the operation;
performing a process for converting the intermediate representation, based on a result of determining whether or not the operation is convertible to another operation; and
executing the intermediate representation after the process for converting the intermediate representation.

### INDUSTRIAL APPLICABILITY

The present invention may be applied to a computation device, a computing method, and a recording medium.

### REFERENCE SIGNS LIST

100, 610 Computation device
110 Communication portion
120 Display portion
130 Operation input portion
180 Memory portion
190 Control portion
210 Front-end portion
220 Parent library
230 Optimization portion
231, 612 Convertibility determination portion
232, 613 Conversion portion
240 Back-end portion
250 Child library
611 Intermediate representation generation portion
614 Intermediate representation execution portion

What is claimed is:

1. A computation device comprising:
a memory configured to store instructions; and
a processor configured to execute the instructions to:
generate an intermediate representation corresponding to a part of a source program, which is a program to be executed;
determine that, among operations indicated by the intermediate representation, an operation a number of times of an object for which is referenced in the source program is one or less is convertible to another operation, the object corresponding to a result of the operation;
perform a process for converting the intermediate representation, based on a result of determining whether or not the operation is convertible to another operation; and
execute the intermediate representation after the process for converting the intermediate representation.

2. The computation device according to claim 1, wherein the processor is configured to execute the instructions to count counts, for each object representing data handled in execution of the source program, a number of times a result of an operation in the source program is referenced, using a reference counter used to manage a lifetime of the object.

3. The computation device according to claim 1, wherein the processor is configured to execute the instructions to determine that an operation a number of times of an object for which is referenced in the source program is greater than a number which is obtained by adding one to a number of times that the object is referenced from a local variable is not convertible to another operation, among operations that are indicated by the intermediate representation and a number of times of an object for which is more than once, the object corresponding to a result of the operation.

4. The computation device according to claim 3, wherein the processor is configured to execute the instructions to refer refers to a stack frame of a function in the source program to obtain information indicating a local variable in the function.

5. The computation device according to claim 4, wherein the processor is configured to execute the instructions to, in the case of not being able to identify a stack frame of a function that called an instruction that triggers execution of the intermediate representation in the source program, determine that an operation that is indicated by the intermediate representation and a number of times of an object for which is referenced in the source program is more than once is not convertible to another operation, the object corresponding to a result of the operation.

6. The computation device according to claim 5, wherein the processor is configured to execute the instructions to determine that an operation in a function that calls an instruction that triggers execution of the intermediate representation in a source program, which corresponds to an object that is not referenced after the instruction is called, is convertible to another operation.

7. The computation device according to claim 6, wherein the processor is configured to execute the instructions to determine that an operation indicated by the intermediate representation, for which it is not yet determined whether it is convertible to another operation, is not convertible to another operation.

8. A computation method executed by a computer, comprising:
generating an intermediate representation corresponding to a part of a source program, which is a program to be executed;
determining that, among operations indicated by the intermediate representation, an operation a number of times of an object for which is referenced in the source program is one or less is convertible to another operation, the object corresponding to a result of the operation;
performing a process for converting the intermediate representation, based on a result of determining whether or not the operation is convertible to another operation; and
executing the intermediate representation after the process for converting the intermediate representation.

9. A non-transitory recording medium that records a program for causing a computer to execute:
generating an intermediate representation corresponding to a part of a source program, which is a program to be executed;
determining that, among operations indicated by the intermediate representation, an operation a number of times of an object for which is referenced in the source program is one or less is convertible to another operation, the object corresponding to a result of the operation;
performing a process for converting the intermediate representation, based on a result of determining whether or not the operation is convertible to another operation; and
executing the intermediate representation after the process for converting the intermediate representation.
